(19) United States
(12) Patent Application Publication
(10) Pub. No.: US 2006/0069567 A1
(43) Pub. Date: Mar. 30, 2006

(54) Methods, systems, and products for translating text to speech

(76) Inventors: Steven N. Tischer, Atlanta, GA (US); Robert A. Koch, Norcross, GA (US); Dale Malik, Atlanta, GA (US)

Correspondence Address: SCOTT P. ZIMMERMAN, PLLC, PO BOX 3822, CARY, NC, 27519, US

(21) Appl. No.: 11/267,092

(22) Filed: Nov. 5, 2005

Related U.S. Application Data
(63) Continuation-in-part of application No. 10/012,946, filed on Dec. 10, 2001.

(51) Int. Cl. G10L 13/08

(52) U.S. Cl. 704/260

(57) ABSTRACT

Methods, systems, and products are disclosed for translating text to speech. One such method receives content for translation to speech, identifies a textual sequence in the content, and correlates the textual sequence to a phrase. A voice file storing multiple phrases is accessed, with the voice file mapping each phrase to a corresponding sequential string of phonemes. The sequential string of phonemes, corresponding to the phrase, is retrieved and processed when translating the textual sequence to speech.

### CROSS-REFERENCE TO RELATED APPLICATIONS

This application is a continuation-in-part of U.S. application Ser. No. 10/012,946, filed Dec. 10, 2001 and entitled “Method and System For Customizing Voice Translation of Text to Speech” (BS01238), and incorporated herein by reference in its entirety.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The exemplary embodiments generally relate to computerized voice translation of text to speech. The exemplary embodiments, more particularly, apply a selected voice file of a known speaker to a translation.

Speech is an important mechanism for improving access and interaction with digital information via computerized systems. Voice-recognition technology has been in existence for some time and is improving in quality. A type of technology similar to voice-recognition systems is speech-synthesis technology, including “text-to-speech” translation. While there has been much attention and development in the voice-recognition area, mechanical production of speech having characteristics of normal speech from text is not well developed.

In text-to-speech (TTS) engines, samples of a voice are recorded, and then used to interpret text with sounds in the recorded voice sample. However, in speech produced by conventional TTS engines, attributes of normal speech patterns, such as speed, pauses, pitch, and emphasis, are generally not present or consistent with a human voice, and in particular not with a specific voice. As a result, voice synthesis in conventional text-to-speech conversions is typically machine-like. Such mechanical-sounding speech is usually distracting and often of such low quality as to be inefficient and undesirable, if not unusable.

Effective speech production algorithms capable of matching text with normal speech patterns of individuals and producing high fidelity human voice translations consistent with those individual patterns are not conventionally available. Even the best voice-synthesis systems allow little variation in the characteristics of the synthetic voices available for speaking textual content. Moreover, conventional voice-synthesis systems do not allow effective customizing of text-to-speech conversions based on voices of actual, known, recognizable speakers.

Thus, there is a need to provide systems and methods for producing high-quality sound, true-to-life translations of text to speech, and translations having speech characteristics of individual speakers. There is also a need to provide systems and methods for customizing text-to-speech translations based on the voices of actual, known speakers.

Voice synthesis systems often use phonetic units, such as phonemes, phones, or some variation of these units, as a basis to synthesize voices. Phonetics is the branch of linguistics that deals with the sounds of speech and their production, combination, description, and representation by written symbols. In phonetics, the sounds of speech are represented with a set of distinct symbols, each symbol designating a single sound. A phoneme is the smallest phonetic unit in a language that is capable of conveying a distinction in meaning, as the “m” in “mat” and the “b” in “bat” in English. A linguistic phone is a speech sound considered without reference to its status as a phoneme or an allophone (a predictable variant of a phoneme) in a language (The American Heritage Dictionary of the English Language, Third Edition).

Text-to-speech translations typically use pronouncing dictionaries to identify phonetic units, such as phonemes. As an example, for the text “How is it going?”, a pronouncing dictionary indicates that the phonetic sound for the “H” in “How” is “huh.” The “huh” sound is a phoneme. One difficulty with text-to-speech translation is that there are a number of ways to say “How is it going?” with variations in speech attributes such as speed, pauses, pitch, and emphasis, for example.

One of the disadvantages of conventional text-to-speech conversion systems is that such technology does not effectively integrate phonetic elements of a voice with other speech characteristics. Thus, currently available text-to-speech products do not produce true-to-life translations based on phonetic, as well as other speech characteristics, of a known voice. For example, the IBM voice-synthesis engine “DirectTalk” is capable of “speaking” content from the Internet using stock, mechanically-synthesized voices of one male or one female, depending on content tags the engine encounters in the markup language, for example HTML. The IBM engine does not allow a user to select from among known voices. The AT&T “Natural Voices” TTS product provides an improved quality of speech converted from text, but allows choosing only between two male voices and one female voice. In addition, the AT&T “Natural Voices” product is very expensive. Thus, there is a need to provide systems and methods for customizing text-to-speech translations based on speech samples including, for example, phonetic, and other speech characteristics such as speed, pauses, pitch, and emphasis, of a selected known voice.

Although conventional TTS systems do not allow users to customize translations with known voices, other communication formats use customizable means of expression. For example, print fonts store characters, glyphs, and other linguistic communication tools in a standardized machine-readable matrix format that allow changing styles for printed characters. As another example, music systems based on a Musical Instrument Digital Interface (MIDI) format allow collections of sounds for specific instruments to be stored by numbers based on the standard piano keyboard. MIDI-type systems allow music to be played with the sounds of different musical instruments by applying files for selected instruments. Both print fonts and MIDI files can be distributed from one device to another for use in multiple devices.

However, conventional TTS systems do not provide for records, or files, of multiple voices to be distributed for use in different devices. Thus, there is a need to provide systems and methods that allow voice files to be easily created, stored, and used for customizing translation of text to speech based on the voices of actual, known speakers. There is also a need for such systems and methods based on phonetic or other methods of dividing speech, that include other speech characteristics of individual speakers, and that can be readily distributed.

### SUMMARY

The exemplary embodiments provide methods, systems, and products of customizing voice translation of a text to speech, including digitally recording speech samples of a specific known speaker and correlating each of the speech samples with a standardized audio representation. The recorded speech samples and correlated audio representations are organized into a collection and saved as a single voice file. The voice file is stored in a device capable of translating text to speech, such as a text-to-speech translation engine. The voice file is then applied to a translation by the device to customize the translation using the applied voice file. In other embodiments, such a method further includes recording speech samples of a plurality of specific known speakers and organizing the speech samples and correlated audio representations for each of the plurality of known speakers into a separate collection, each of which is saved as a single voice file. One of the voice files is selected and applied to a translation to customize the text-to-speech translation. Speech samples can include samples of speech speed, emphasis, rhythm, pitch, and pausing of each of the plurality of known speakers.

Exemplary embodiments include combining voice files to create a new voice file and storing the new voice file in a device capable of translating text to speech. Other exemplary embodiments distribute voice files to other devices capable of translating text to speech. Some exemplary embodiments utilize standardized audio representations comprising phonemes. Phonemes can be labeled, or classified, with a standardized identifier such as a unique number. A voice file comprising phonemes can include a particular sequence of unique numbers. In other exemplary embodiments, standardized audio representations comprise other systems and/or means for dividing, classifying, and organizing voice components.

The text translated to speech is content accessed in a computer network, such as an electronic mail message. In other exemplary embodiments, the text translated to speech comprises text communicated through a telecommunications system.

Exemplary embodiments may be accomplished singularly or in combination. As will be appreciated by those of ordinary skill in the art, the exemplary embodiments have wide utility in a number of applications as illustrated by the variety of features and advantages discussed below.

Exemplary embodiments provide numerous advantages over prior approaches. For example, exemplary embodiments advantageously provide customized voice translation of machine-read text based on voices of specific, actual, known speakers. Exemplary embodiments provide recording, organizing, and saving voice samples of a speaker into a voice file that can be selectively applied to a translation. Exemplary embodiments provide a standardized means of identifying and organizing individual voice samples into voice files. Exemplary embodiments utilize standardized audio representations, such as phonemes, to create more natural and intelligible text-to-speech translations. Exemplary embodiments distribute voice files of actual speakers to other devices and locations for customizing text-to-speech translations with recognizable voices. Exemplary embodiments allow persons to listen to more natural and intelligible translations using recognizable voices, which will facilitate listening with greater clarity and for longer periods without fatigue or becoming annoyed. Exemplary embodiments utilize voice files to customize translation of content accessed in a computer network, such as an electronic mail message, and text communicated through a telecommunications system. Exemplary embodiments can be applied to almost any business or consumer application, product, device, or system, including software that reads digital files aloud, automated voice interfaces, in educational contexts, and in radio and television advertising. Exemplary embodiments use voice files to customize text-to-speech translations in a variety of computing platforms, ranging from computer network servers to handheld devices.

Exemplary embodiments include a method for translating text to speech. Content is received for translation to speech. A textual sequence in the content is identified and correlated to a phrase. A voice file storing multiple phrases is accessed, with the voice file mapping each phrase to a corresponding sequential string of phonemes. The sequential string of phonemes, corresponding to the phrase, is retrieved and processed when translating the textual sequence to speech.

More exemplary embodiments describe a system for translating text to speech. The system includes a text-to-speech translation application stored in memory, and a processor communicates with the memory. The text-to-speech translation application receives content for translation to speech, identifies a textual sequence in the content, and correlates the textual sequence to a phrase. The text-to-speech translation application accesses a voice file storing multiple phrases, with the voice file mapping each phrase to a corresponding sequential string of phonemes stored in the voice file. The text-to-speech translation application retrieves the sequential string of phonemes corresponding to the phrase and processes the sequential string of phonemes when translating the textual sequence to speech.

Other exemplary embodiments describe a computer program product for translating text to speech. This computer program product comprises computer-readable instructions for receiving content for translation to speech, identifying a textual sequence in the content, and correlating the textual sequence to a phrase. A voice file storing multiple phrases is accessed, with the voice file mapping each phrase to a corresponding sequential string of phonemes. The sequential string of phonemes, corresponding to the phrase, is retrieved and processed when translating the textual sequence to speech.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a diagram of a text-to-speech translation voice customization system, according to exemplary embodiments.

FIG. 2 is a flow chart of a method for customizing voice translation of text to speech, according to exemplary embodiments.

FIG. 3 is a diagram illustrating components of a voice file, according to more exemplary embodiments.

FIG. 4 is a diagram illustrating phonemes recorded for a voice sample and application of the recorded phonemes to a translation of text to speech, according to exemplary embodiments.

FIG. 5 is a diagram illustrating voice files of a plurality of known speakers stored in a text-to-speech translation device, according to more exemplary embodiments.

FIG. 6 is a diagram of the text-to-speech translation device shown in FIG. 4, according to yet more exemplary embodiments.

FIG. 7 is a schematic illustrating the TTS engine receiving content from a network, according to exemplary embodiments.

FIG. 8 is a schematic illustrating combined phrasings, according to more exemplary embodiments.

FIG. 9 is a schematic illustrating a voice file, according to more exemplary embodiments.

FIG. 10 is a schematic illustrating a tag, according to more exemplary embodiments.

FIG. 11 is a schematic illustrating “morphing” of voice files, according to still more exemplary embodiments.

FIG. 12 is a schematic illustrating delta voice files, according to yet more exemplary embodiments.

FIG. 13 is a schematic illustrating authentication of translated speech, according to exemplary embodiments.

FIG. 14 is a schematic illustrating a network-centric authentication, according to exemplary embodiments.

FIGS. 15 and 16 are flowcharts illustrating a method of translating text to speech, according to more exemplary embodiments.

FIG. 17 is a flowchart illustrating a method of authenticating speech, according to more exemplary embodiments

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the claims to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

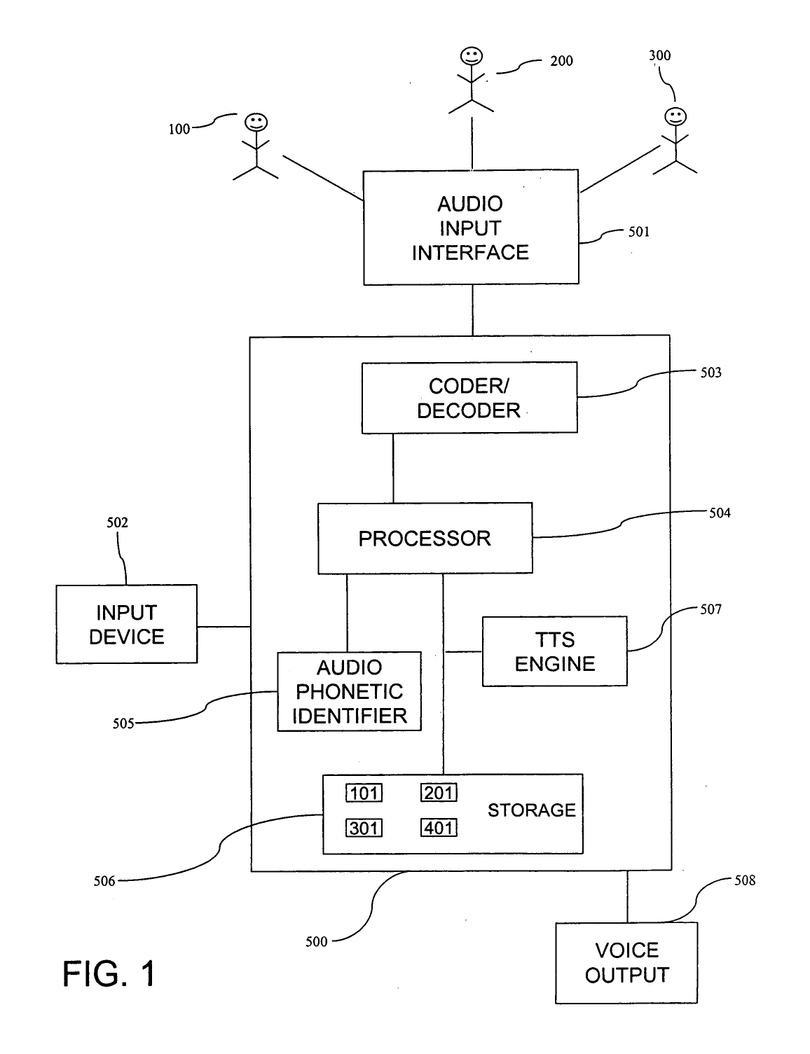

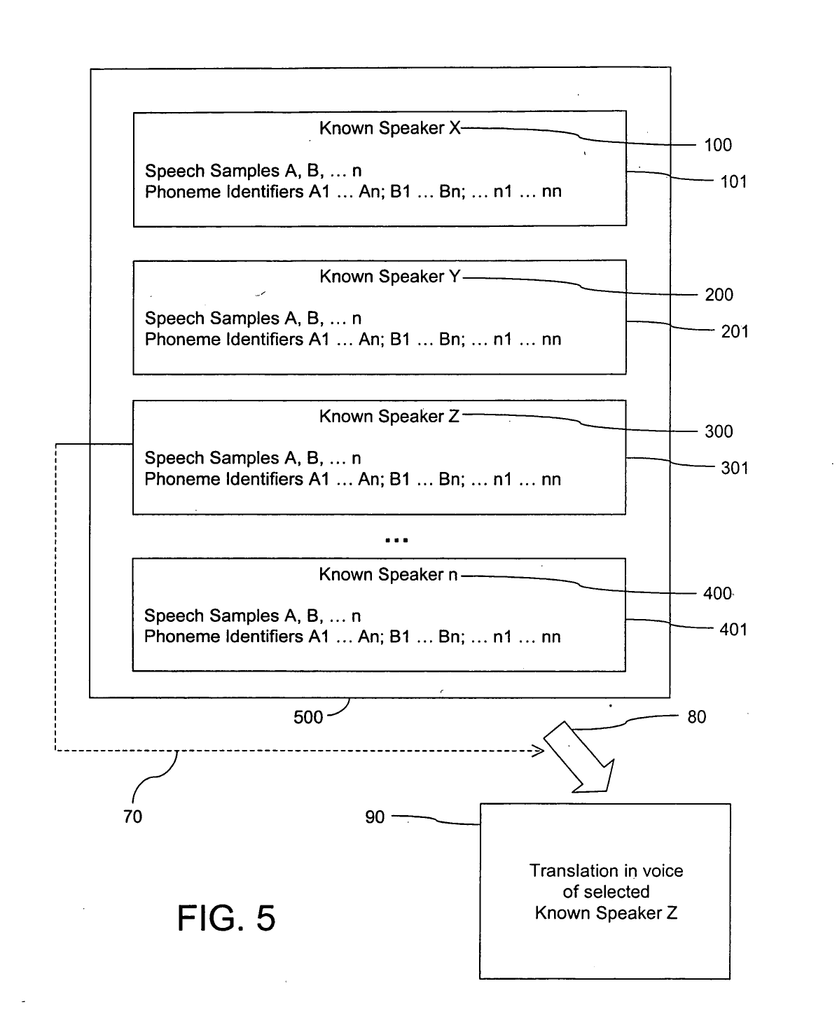

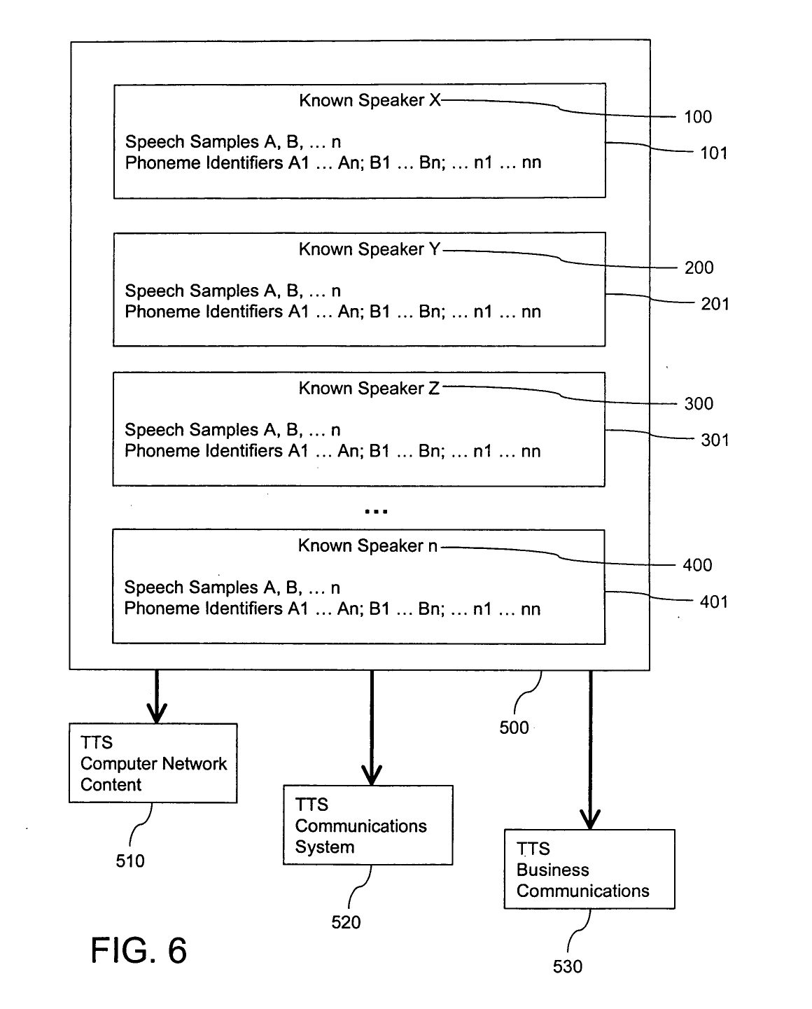

FIG. 1 shows one embodiment of a text-to-speech translation voice customization system. Referring to FIG. 1, the known speakers X (100), Y (200), and Z (300) provide speech samples via the audio input interface 501 to the text-to-speech translation device 500. The speech samples are processed through the coder/decoder, or codec 503, that converts analog voice signals to digital formats using conventional speech processing techniques. An example of such speech processing techniques is perceptual coding, such as digital audio coding, which enhances sound quality while permitting audio data to be transmitted at lower transmission rates. In the translation device 500, the audio phonetic identifier 505 identifies phonetic elements of the speech samples and correlates the phonetic elements with standardized audio representations. The phonetic elements of speech sample sounds and their correlated audio representations are stored as voice files in the storage space 506 of translation device 500. In FIG. 1, as also shown in FIGS. 5 and 6, the voice file 101 of known speaker X (100), the voice file 201 of known speaker Y (200), the voice file 301 of known speaker Z (300), and the voice file 401 of known speaker “n” (not shown in FIG. 1) is each stored in storage space 506. In the translation device 500, the text-to-speech engine 507 translates a text to speech utilizing one of the voice files 101, 201, 301, and 401, to produce a spoken text in the selected voice using voice output device 508. Operation of these components in the translation device 500 is processed through processor 504 and manipulated with external input device 502, such as a keyboard.

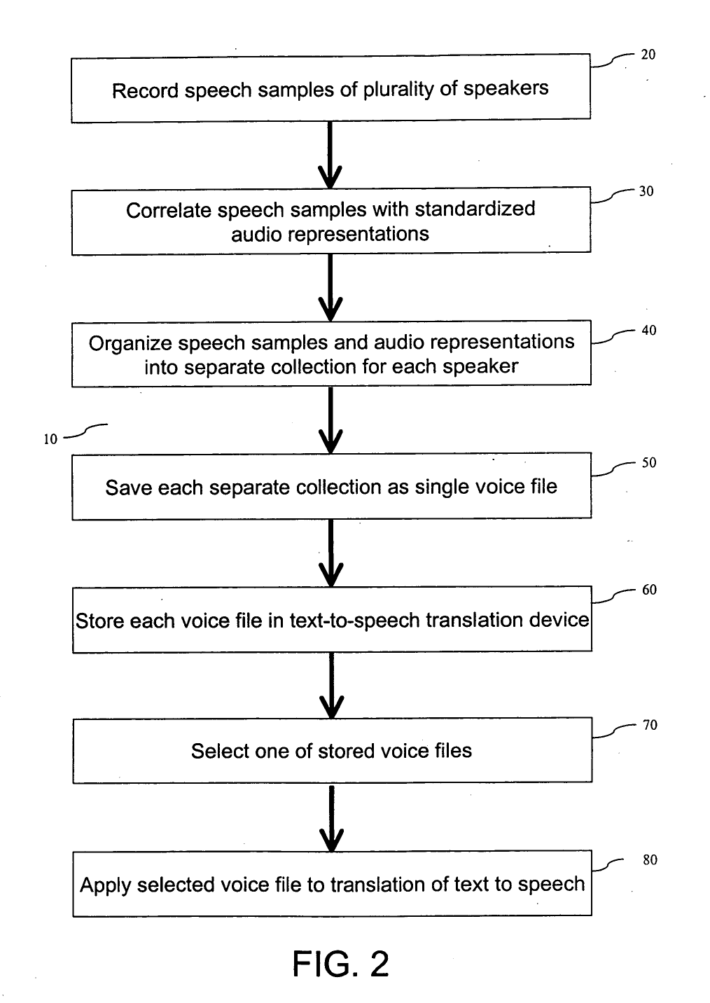

Other embodiments comprise a method for customizing voice translations of text to speech that allows translation of a text with a voice file of a specific known speaker. FIG. 2 shows one such embodiment. Referring to FIG. 2, a method 10 for customizing text-to-speech voice translations according to exemplary embodiments. The method 10 includes recording speech samples of a plurality of speakers (20), for example using the audio input interface 501 shown in FIG. 1. The method 10 further includes correlating the speech samples with standardized audio representations (30), which can be accomplished with audio phonetic identification software such as the audio phonetic identifier 505. The speech samples and correlated audio representations are organized into a separate collection for each speaker (40). The separate collection of speech samples and audio representations for each speaker is saved (50) as a single voice file. Each voice file is stored (60) in a text-to-speech (TTS) translation device, for example in the storage space 506 in TTS translation device 500. A TTS device may have any number of voice files stored for use in translating speech to text. A user of the TTS device selects (70) one of the stored voice files and applies (80) the selected voice file to a translation of text to speech using a TTS engine, such as TTS engine 507. In this manner, a text is translated to speech using the voice and speech patterns and attributes of a known speaker. In other embodiments, selection of a voice file for application to a particular translation is controlled by a signal associated with transmitted content to be translated. If the voice file requested is not resident in the receiving device, the receiving device can then request transmission of the selected voice file from the source transmitting the content. Alternatively, content can be transmitted with preferences for voice files, from which a receiving device would select from among voice files resident in the receiving device.

In exemplary embodiments, a voice file comprises distinct sounds from speech samples of a specific known speaker. Distinct sounds derived from speech samples from the speaker are correlated with particular auditory representations, such as phonetic symbols. The auditory representations can be standardized phonemes, the smallest phonetic units capable of conveying a distinction in meaning. Alternatively, auditory representations include linguistic phones, such as diphones, triphones, and tetraphones, or other linguistic units or sequences. In addition to phonetic-based systems, exemplary embodiments can be based on any system which divides sounds of speech into classifiable components. Auditory representations are further classified by assigning a standardized identifier to each of the auditory representations. Identifiers may be existing phoneme nomenclature or any means for identifying particular sounds. Preferably, each identifier is a unique number. Unique number identifiers, each identifier representing a distinct sound, are concatenated, or connected together in a series to form a sequence.

As shown in the embodiment in FIG. 2, sounds from speech samples and correlated audio representations are organized (40) into a collection and saved (50) as a single voice file for a speaker. Voice files comprise various formats, or structures. For example, a voice file can be stored as a matrix organized into a number of locations each inhabited by a unique voice sample, or linguistic representation. A voice file can also be stored as an array of voice samples. In a voice file, speech samples comprise sample sounds spoken by a particular speaker. In embodiments, speech samples include sample words spoken, or read aloud, by the speaker from a pronouncing dictionary. Sample words in a pronouncing dictionary are correlated with standardized phonetic units, such as phonemes. Samples of words spoken from a pronouncing dictionary contain a range of distinct phonetic units representative of sounds comprising most spoken words in a vocabulary. Samples of words read from such standardized sources provide representative samples of a speaker's natural intonations, inflections, pitch, accent, emphasis, speed, rhythm, pausing, and emotions such as happiness and anger.

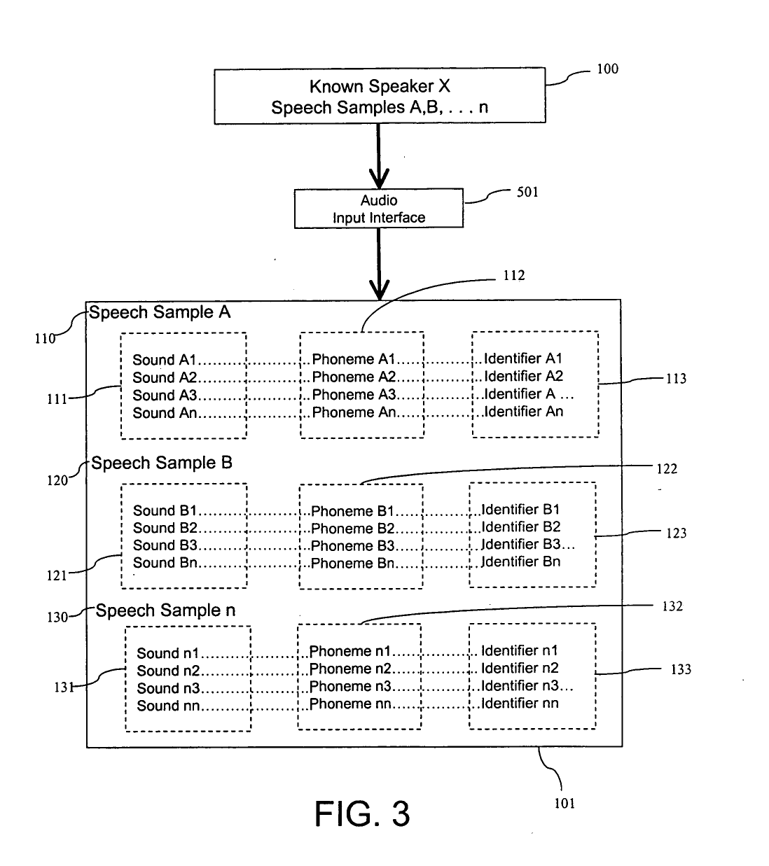

As an example, FIG. 3 shows a voice file 101. The voice file 101 comprises speech samples A, B, . . . n of known speaker X (100). Speech samples A, B, . . . n are recorded using a conventional audio input interface 501. Speech sample A (110) comprises sounds A1, A2, A3, . . . An (111), which are recorded from sample words read by speaker X (100) from a pronouncing dictionary. Sounds A1, A2, A3, . . . . An (111) are correlated with phonemes A1, A2, A3, . . . . An (112), respectively. Each of phonemes A1, A2, A3, . . . An (112) is further assigned a standardized identifier A1, A2, A3, . . . An (113), respectively.

In embodiments, a single voice file comprises speech samples using different linguistic systems. For example, a voice file can include samples of an individual's speech in which the linguistic components are phonemes, samples based on triphones, and samples based on other linguistic components. Speech samples of each type of linguistic component are stored together in a file, for example, in one section of a matrix.

The number of speech samples recorded is sufficient to build a file capable of providing a natural-sounding translation of text. Generally, samples are recorded to identify a pre-determined number of phonemes. For example, 39 standard phonemes in the Carnegie Mellon University Pronouncing Dictionary allow combinations that form most words in the English language. However, the number of speech samples recorded to provide a natural-sounding translation varies between individuals, depending upon a number of lexical and linguistic variables. For purposes of illustration, a finite but variable number of speech samples is represented with the designation “A, B, . . . n”, and a finite but variable number of audio representations within speech samples is represented with the designation “1, 2, 3, . . . n.”

Similar to speech sample A (110) in FIG. 3, speech sample B (120) includes sounds B1, B2, B3, . . . Bn (121), which include samples of the natural intonations, inflections, pitch, accent, emphasis, speed, rhythm, and pausing of speaker X (100). Sounds B1, B2, B3, . . . Bn (121) are correlated with phonemes B1, B2, B3, . . . Bn (122), respectively, which are in turn assigned a standardized identifier B1, B2, B3, . . . Bn (123), respectively. Each speech sample recorded for known speaker X (120) comprises sounds, which are correlated with phonemes, and each phoneme is further classified with a standardized identifier similar to that described for speech samples A (110) and B (120). Finally, speech sample n (130) includes sounds n1, n2, n3, . . . nn (131), which are correlated with phonemes n1, n2, n3, . . . nn (132), respectively, which are in turn assigned a standardized identifier n1, n2, n3, . . . nn (133), respectively. The collection of recorded speech samples A, B, . . . n (110, 120, 130) having sounds (111, 121, 131) and correlated phonemes (112, 122, 132) and identifiers (113, 123, 133) comprise the voice file 101 for known speaker X (100).

In exemplary embodiments, a voice file having distinct sounds, auditory representations, and identifiers for a particular known speaker comprises a “voice font.” Such a voice file, or font, is similar to a print font used in a word processor. A print font is a complete set of type of one size and face, or a consistent typeface design and size across all characters in a group. A word processor print font is a file in which a sequence of numbers represents a particular typeface design and size for print characters. Print font files often utilize a matrix having, for example 256 or 64,000, locations to store a unique sequence of numbers representing the font.

In operation, a print font file is transmitted along with a document, and instantiates the transmitted print characters. Instantiation is a process by which a more defined version of some object is produced by replacing variables with values, such as producing a particular object from its class template in object-oriented programming. In an electronically transmitted print document, a print font file instantiates, or creates an instance of, the print characters when the document is displayed or printed.

For example, a print document transmitted in the Times New Roman font has associated with it the print font file having a sequence of numbers representing the Times New Roman font. When the document is opened, the associated print font file instantiates the characters in the document in the Times New Roman font. A desirable feature of a print font file associated with a set of print characters is that it can be easily changed. For example, if it is desired to display and/or print a set of characters, or an entire document, saved in Times New Roman font, the font can be changed merely by selecting another font, for example the Arial font. Similar to a print font in a word processor, for a “voice font,” sounds of a known speaker are recorded and saved in a voice font file. A voice font file for a speaker can then be selected and applied to a translation of text to speech to instantiate the translated speech in the voice of that particular speaker.

Voice files can be named in a standardized fashion similar to naming conventions utilized with other types of digital files. For example, a voice file for known speaker X could be identified as VoiceFileX.vof, voice file for known speaker Y as VoiceFileY.vof, and voice file for known speaker Z as VoiceFileZ.vof. By labeling voice files in such a standardized manner, voice files can be shared with reliability between applications and devices. A standardized voice file naming convention allows lees than an entire voice file to be transmitted from one device to another. Since one device or program would recognize that a particular voice file was resident on another device by the name of the file, only a subset of the voice file would need to be transmitted to the other device in order for the receiving device to apply the voice file to a text translation. In addition, voice files can be expressed in a World Wide Web Consortium-compliant extensible syntax, for example in a standard mark-up language file such as XML. A voice file structure could comprise a standard XML file having locations at which speech samples are stored. For example, in embodiments, “VoiceFileX.vof” transmitted via a markup language would include “markup” indicating that text by individual X would be translated using VoiceFileX.vof.

According to In exemplary embodiment, auditory representations of separate sounds in digitally-recorded speech samples are assigned unique number identifiers. A sequence of such numbers stored in specific locations in an electronic voice file provides linguistic attributes for substantiation of voice-translated content consistent with a particular speaker's voice. Standardization of voice sounds and speech attributes in a digital format allows easy selection and application of one speaker's voice file, or that of another, to a text-to-speech translation. In addition, digital voice files can be readily distributed and used by multiple text-to-speech translation devices. Once a voice file has been stored in a device, the voice file can then be used on demand and without being retransmitted with each set of content to be translated.

Voice files, or fonts, in such embodiments operate in a manner similar to sound recordings using a Musical Instrument Digital Interface (MIDI) format. In a MIDI system, a single, separate musical sound is assigned a number. As an example, a MIDI sound file for a violin includes all the numbers for notes of the violin. Selecting the violin file causes a piece of music to be controlled by the number sequences in the violin file, and the music is played utilizing the separate digital recordings of a violin from the violin file, thereby creating a violin audio. To play the same music piece by some other instrument, the MIDI file, and number sequences, for that instrument is selected. Similarly, translation of text to speech can be easily changed from one voice file to another.

Sequential number voice files can be stored and transmitted using various formats and/or standards. A voice file can be stored in an ASCII (American Standard Code for Information Interchange) matrix or chart. As described above, a sequential number file can be stored as a matrix with 256 locations, known as a “font.” Another example of a format in which voice files can be stored is the “unicode” standard, a data storage means similar to a font but having exponentially higher storage capacity. Storage of voice files using a “unicode” standard allows storage, for example, of attributes for multiple languages in one file. Accordingly, a single voice file could comprise different ways to express a voice and/or use a voice file with different types of voice production devices.

Exemplary embodiments may correlate distinct sounds in speech samples with audio representations. Phonemes are one such example of audio representations. When the voice file of a known speaker is applied (80) to a text, phonemes in the text are translated to corresponding phonemes representing sounds in the selected speaker's voice such that the translation emulates the speaker's voice.

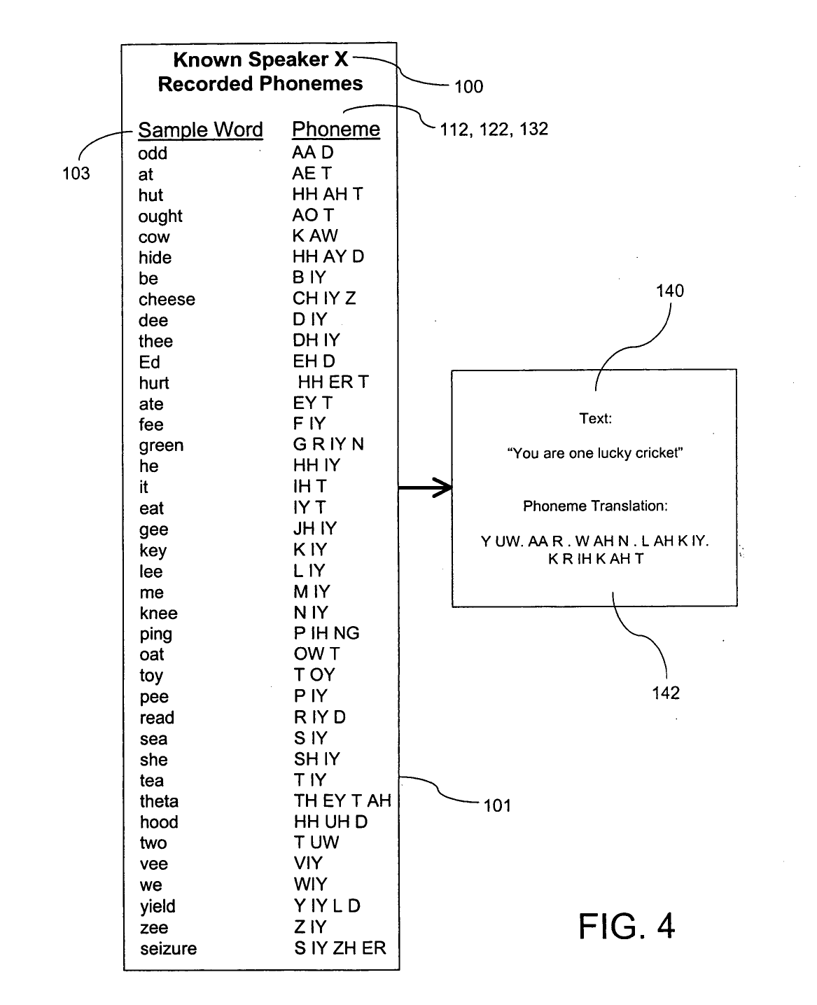

FIG. 4 illustrates an example of translation of text using phonemes in a voice file. Embodiments of the voice file for the voice of a specific known speaker include all of the standardized phonemes as recorded by that speaker. In the example in FIG. 4, the voice file for known speaker X (100) includes recorded speech samples comprising the 39 standard phonemes in the Carnegie Mellon University (CMU) Pronouncing Dictionary listed in the table below:

| Alpha Symbol | Sample Word | Phoneme |
|---|---|---|
| AA | odd | AA D |
| AE | at | AE T |
| AH | hut | HH AH T |
| AO | ought | AO T |
| AW | cow | K AW |
| AY | hide | HH AY D |
| B | be | B IY |
| CH | cheese | CH IY Z |
| D | dee | D IY |
| DH | thee | DH IY |
| EH | Ed | EH D |
| ER | hurt | HH ER T |
| EY | ate | EY T |
| F | fee | F IY |
| G | green | G R IY N |
| HH | he | HH IY |
| IH | it | IH T |
| IY | eat | IY T |
| JH | gee | JH IY |
| K | key | K IY |
| L | lee | L IY |
| M | me | M IY |
| N | knee | N IY |
| NG | ping | P IH NG |
| OW | oat | OW T |
| OY | toy | T OY |
| P | pee | P IY |
| R | read | R IY D |
| S | sea | S IY |
| SH | she | SH IY |
| T | tea | T IY |
| TH | theta | TH EY T AH |
| UH | hood | HH UH D |
| UW | two | T UW |
| V | vee | V IY |
| W | we | W IY |
| Y | yield | Y IY L D |
| Z | zee | Z IY |
| ZH | seizure | S IY ZH ER |

Sounds in sample words 103 recorded by known speaker X (100) are correlated with phonemes 112, 122, 132. The textual sequence 140, “You are one lucky cricket” (from the Disney movie “Mulan”), is converted to its constituent phoneme string using the CMU Phoneme Dictionary. Accordingly, the phoneme translation 142 of text 140 “You are one lucky cricket” is: Y UW. AA R. W AH N . L AH K IY. K R IH K AH T. When the voice file 101 is applied, the phoneme pronunciations 112, 122, 132 as recorded in the speech samples by known speaker X (100) are used to translate the text to sound like the voice of known speaker X (100).

According to exemplary embodiments, a voice file includes speech samples comprising sample words. Because sounds from speech samples are correlated with standardized phonemes, the need for more extensive speech sample recordings is significantly decreased. The CMU Pronouncing Dictionary is one example of a source of sample words and standardized phonemes for use in recording speech samples and creating a voice file. In other embodiments, other dictionaries including different phonemes are used. Speech samples using application-specific dictionaries and/or user-defined dictionaries can also be recorded to support translation of words unique to a particular application.

Recordings from such standardized sources provide representative samples of a speaker's natural intonations, inflections, and accent. Additional speech samples can also be recorded to gather samples of the speaker when various phonemes are being emphasized and using various speeds, rhythms, and pauses. Other samples can be recorded for emphasis, including high and low pitched voicings, as well as to capture voice-modulating emotions such as joy and anger. In embodiments using voice files created with speech samples correlated with standardized phonemes, most words in a text can be translated to speech that sounds like the natural voice of the speaker whose voice file is used. As such, exemplary embodiments provide for more natural and intelligible translations using recognizable voices that will facilitate listening with greater clarity and for longer periods without fatigue or becoming annoyed.

In other embodiments, voice files of animate speakers are modified. For example, voice files of different speakers can be combined, or “morphed,” to create new, yet naturally-sounding voice files. Such embodiments have applications including movies, in which inanimate characters can be given the voice of a known voice talent, or a modified but natural voice. In other embodiments, voice files of different known speakers are combined in a translation to create a “morphed” translation of text to speech, the translation having attributes of each speaker. For example, a text including a one author quoting another author could be translated using the voice files of both authors such that the primary author's voice file is use to translate that author's text and the quoted author's voice file is used to translate the quotation from that author.

Exemplary embodiments apply voice files to a translation in conventional text-to-speech (TTS) translation devices, or engines. TTS engines are generally implemented in software using standard audio equipment. Conventional TTS systems are concatenative systems, which arrange strings of characters into a connected list, and typically include linguistic analysis, prosodic modeling, and speech synthesis. Linguistic analysis includes computing linguistic representations, such as phonetic symbols, from written text. These analyses may include analyzing syntax, expanding digit sequences into words, expanding abbreviations into words, and recognizing ends of sentences. Prosodic modeling refers to a system of changing prose into metrical or verse form. Speech synthesis transforms a given linguistic representation, such as a chain of phonetic symbols, enhanced by information on phrasing, intonation, and stress, into artificial, machine-generated speech by means of an appropriate synthesis method. Conventional TTS systems often use statistical methods to predict phrasing, word accentuation, and sentence intonation and duration based on pre-programmed weighting of expected, or preferred, speech parameters. Speech synthesis methods include matching text with an inventory of acoustic elements, such as dictionary-based pronunciations, concatenating textual segments into speech, and adding predicted, parameter-based speech attributes.

Exemplary embodiments select a voice file from among a plurality of voice files available to apply to a translation of text to speech. For example, in FIG. 5, voice files of a number of known speakers are stored for selective use in TTS translation device 500. Individualized voice files 101, 201, 301, and 401 comprising speech samples, correlated phonemes, and identifiers of known speakers X (100), Y (200), Z (300), and n (400), respectively, are stored in TTS device 500. One of the stored voice files 301 for known speaker Z (300) is selected (70) from among the available voice files. Selected voice file 301 is applied (80) to a translation 90 of text so that the resulting speech is voiced according to the voice file 301, and the voice, of known speaker Z (300).

Such an embodiment as illustrated in FIG. 5 has many applications, including in the entertainment industry. For example, speech samples of actors can be recorded and associated with phonemes to create a unique number sequence voice file for each actor. To experiment with the type of voices and the voices of particular actors that would be most appropriate for parts in a screen play, for example, text of the play could be translated into speech, or read, by voice files of selected actors stored in a TTS device. Thus, the screen play text could be read using voice files of different known voices, to determine a preferred voice, and actor, for a part in the production.

Text-to-speech conversions using voice files are useful in a wide range of applications. Once a voice file has been stored in a TTS device, the voice file can be used on demand. As shown in FIG. 5, a user can simply select a stored voice file from among those available for use in a particular situation. In addition, digital voice files can be readily distributed and used in multiple TTS translation devices. In another aspect, when a desired voice file is already resident in a device, it is not necessary to transmit the voice file along with a text to be translated with that particular voice file.

FIG. 6 illustrates distribution of voice files to multiple TTS devices for use in a variety of applications. In FIG. 6, voice files 101, 201, 301, and 401 comprising speech samples, correlated phonemes, and identifiers of known speakers X (100), Y (200), Z (300), and n (400), respectively, are stored in TTS device 500. Voice files 101, 201, 301, and 401 can be distributed to TTS device 510 for translating content on a computer network, such as the Internet, to speech in the voices of known speakers X (100), Y (200), Z (300), and n (400), respectively.

Specific voice files can be associated with specific content on a computer network, including the Internet, or other wide area network, local area networks, and company-based “Intranets.” Content for text-to-speech translation can be accessed using a personal computer, a laptop computer, personal digital assistant, via a telecommunication system, such as with a wireless telephone, and other digital devices. For example, a family member's voice file can be associated with electronic mail messages from that particular family member so that when an electronic mail message from that family member is opened, the message content is translated, or read, in the family member's voice. Content transmitted over a computer network, such as XML and HTML-formatted transmissions, can be labeled with descriptive tags that associate those transmissions with selected voice files. As an example, a computer user can tag news or stock reports received over a computer network with associations to a voice file of a favorite newscaster or of their stockbroker. When a tagged transmission is received, the transmitted content is read in the voice represented by the associated voice file. As another example, textual content on a corporate intranet can be associated with, and translated to speech by, the voice file of the division head posting the content, of the company president, or any other selected voice file.

Another example of translating computer network content using voice files involves “chat rooms” on the internet. Voice files of selected speakers, including a chat room participant's own voice file, can be used to translate textual content transmitted in a chat room conversation into speech in the voice represented by the selected voice file.

Exemplary embodiments can be used with stand-alone computer applications. For example, computer programs can include voice file editors. Voice file editing can be used, for instance, to convert voice files to different languages for use in different countries.

In addition to applications related to translating content from a computer network, exemplary embodiments are applicable to speech translated from text communicated over a telecommunications system. Referring to FIG. 6, voice files 101, 201, 301, and 401 can be distributed to TTS device 520 for translating text communicated over a telecommunications system to speech in the voices of known speakers X (100), Y (200), Z (300), and n (400), respectively. For example, electronic mail messages accessed by telephone can be translated from text to speech using voice files of selected known speakers. Also, exemplary embodiments can be used to create voice mail messages in a selected voice.

As shown in FIG. 6, voice files 101, 201, 301, and 401 can be distributed to TTS device 530 for translating text used in business communications to speech in the voices of known speakers X (100), Y (200), Z (300), and n (400), respectively. For example, a business can record and store a voice file for a particular spokesperson, whose voice file is then used to translate a new announcement text into a spoken announcement in the voice of the spokesperson without requiring the spokesperson to read the new announcement. In other embodiments, a business selects a particular voice file, and voice, for its telephone menus, or different voice files, and voices, for different parts of its telephone menu. The menu can be readily changed by preparing a new text and translating the text to speech with a selected voice file. In still other embodiments, automated customer service calls are translated from text to speech using selected voice files, depending on the type of call.

Exemplary embodiments have many other useful applications. Embodiments can be used in a variety of computing platforms, ranging from computer network servers to handheld devices, including wireless telephones and personal digital assistants (PDAs). Customized text-to-speech translations, according to exemplary embodiments, can be utilized in any situation involving automated voice interfaces, devices, and systems. Such customized text-to-speech translations are particularly useful in radio and television advertising, in automobile computer systems providing driving directions, in educational programs such as teaching children to read and teaching people new languages, for books on tape, for speech service providers, in location-based services, and with video games.

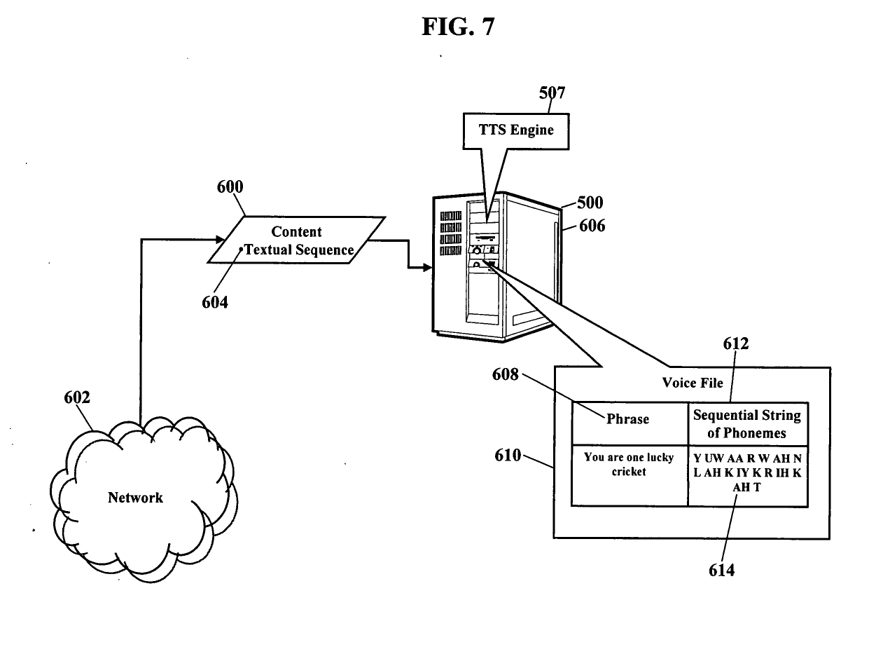

FIG. 7 is a schematic illustrating another exemplary embodiment. Here the TTS engine 507 receives content 600 from a network 602. As the above paragraphs earlier explained, the content 600 may be an electronic message (such as a mail message, instant message, or any textual content) or any packetized data having textual content. The content 600 comprises a textual sequence 604. The TTS engine 507 is shown stored within the translation device 500. Although the translation device 500 may be any processor-controlled device, FIG. 7 illustrates the translation device 500 as a computer 606. When the TTS engine 507 receives the content 600, the TTS engine 507 identifies the textual sequence 604 and correlates the textual sequence 604 to one or more phrases 608. The TTS engine 507 accesses a voice file 610 also stored in the translation device 500. The voice file 610 stores multiple phrases that are mapped by a matrix 612. The matrix 612 maps phrases 608 to a corresponding sequential string 614 of phonemes. Because the TTS engine 507 identified the textual sequence 604 and correlated it to one or more phrases 608, the TTS engine 507 uses the matrix 612 to retrieve the sequential string 614 of phonemes corresponding to the phrase 608. The TTS engine 507 then processes the sequential string 614 of phonemes when translating the textual sequence 604 to speech.

The phrases 608 may be single or multiple words. When the TTS engine 507 identifies the textual sequence 604 and correlates that textual sequence 604 to one or more phrases 608, the TTS engine 507 identifies phrases that are mapped by the matrix 612. The TTS engine 507 parses the content 600 into as long of textual sequences that can be exactly found in the matrix 612. Using the previous example, if the TTS engine 507 can correlate the entire textual sequence “You are one lucky cricket” (again from the DISNEY® movie “MULAN”®) to the same phrase in the matrix 612, then the TTS engine 507 retrieves the corresponding sequential string of phonemes:
[Y UW . AA R . W AH N . L AH K IY . KR IH K AH T.].

The TTS engine 507 successively uses truncation until a matching phrase is located in the matrix 612. Should the entire textual sequence “You are one lucky cricket” not be found in the matrix 612, then the TTS engine 507 truncates the textual sequence 604 and again inspects the matrix 612. Again using Disney's “MULAN”® example, the TTS engine 507 truncates the textual sequence to “You are one lucky” and queries the matrix 612 for this truncated phrase. If the query is negative, the TTS engine 507 again truncates and queries for “You are one.” If at any time the query is affirmative, the TTS engine 507 retrieves the corresponding sequential string of phonemes. If the queries are repeatedly negative (that is, the matrix 612 does not map the exact phrase), then the TTS engine 507 will eventually truncate down to a single word. If the single word is found in the matrix 612, the TTS engine 507 retrieves the corresponding sequential string of phonemes for this single word. If the word is not found in the matrix 612, the TTS engine 507 parses the single word into its constituent syllables. The matrix 612 is queried for the phoneme(s) corresponding to that single syllable. The TTS engine then strings together those phonemes that correspond to the single word. The TTS engine 507 would then repeat this process of mapping and truncating for a new textual sequence.

The phrases 608, then, may even include syllables. The TTS engine 507 first parses the content 600 into as long of textual sequences that can be exactly found in the matrix 612. The voice file 610 (containing or accessing the matrix 612), then, may map common phrases and expressions (e.g., common combinations of words) and their corresponding sequential strings of phonemes. In this way the TTS engine 507 may quickly and efficiently translate entire phrases without first analyzing each phrase into its constituent phonemes. Common phrases and expressions, such as “How are you?” and “I am glad to meet you,” can be quickly mapped to their corresponding sequential strings of phonemes. The matrix 612 may contain common or frequently used noun-verb combinations and grammatical pairings. Any long, medium, or short phrase, in fact, could be mapped by the matrix 612. If the need arose, poems, stories, and even the entire “Pledge of Allegiance” could be mapped to its sequential string of phonemes. The matrix 612, however, could also map single syllables to phonemes and/or map multi-syllables to a corresponding string of phonemes. The TTS engine 507 could retrieve single phonemes or sequential strings of phonemes, depending on the need.

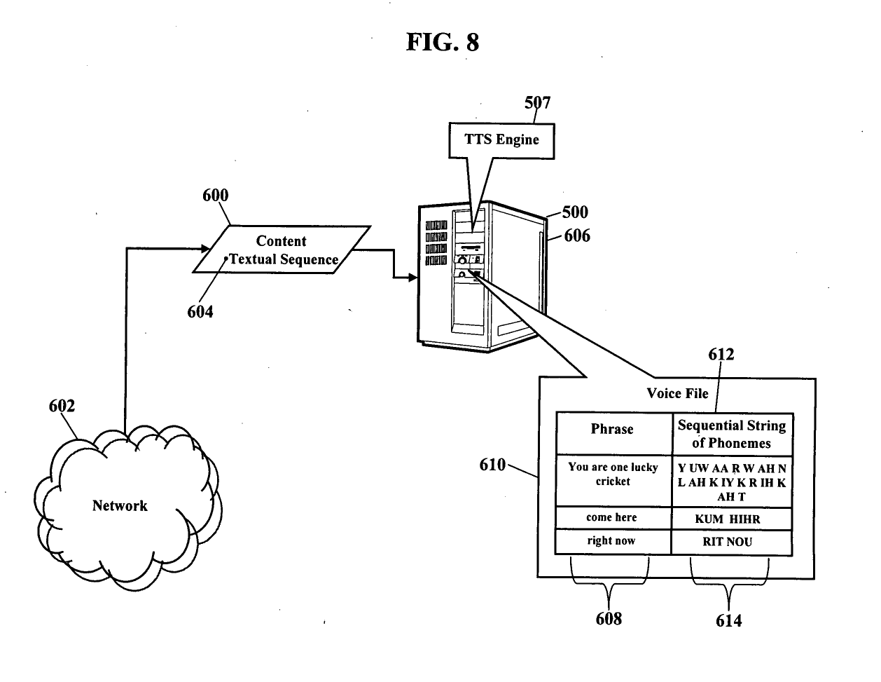

FIG. 8 is a schematic illustrating combined phrasings, according to more exemplary embodiments. Here, when the TTS engine 507 identifies the textual sequence 604, the TTS engine 507 efficiently correlates to combines phrases. That is, if the TTS engine 507 cannot map an entire phrase, then the TTS engine 507 may parse the phrase into at least two smaller, sub-phrases. The TTS engine 507 then maps those sub-phrases to their corresponding sequential strings of phonemes. These at least two sequential strings of phonemes are then combined to form the entire phrase. Suppose the textual sequence 604 is “come here right now.” If that entire phrase is not mapped in the matrix 612, the TTS engine 507 could split or parse that phrase into two separate phrases “come here” and “right now.” These smaller sub-phrases are mapped to their corresponding sequential strings of phonemes. The smaller sequential strings of phonemes are then combined to form the entire phrase “come here right now.” The reader may now appreciate why the matrix 612 may contain common or frequently used noun-verb combinations, grammatical pairings, and phrases. The entries in the matrix 612 may be used to “build” any phrase without first laboriously analyzing an entire phrase into its constituent phonemes.

The matrix 612, then, may map multi-syllable sounds. That is, the matrix 612 may store multiple phonemes that correspond to multi-syllable sounds. These multiple phoneme entries are stored as a single digital item, though that item represents more than one simple sound. Entire phrases, then, can be constructed from smaller sub-phrases and/or multi-syllable sounds stored in the matrix 612. Any of these sub-phrases and/or multi-syllable sounds can be retrieved and concatenated as needed for increasing fidelity, meaning, and efficiency. The phrase “you are one bad boy” could be constructed from the individual phrases “you are” and “one” and “bad” and “boy.” These individual phrases are strung together and their corresponding sequential strings of phonemes are concatenated using a total of four multi-phones. The reader again sees how the entries in the matrix 612 may be used to build any phrase without first laboriously separating an entire phrase into a sequence of words, and then breaking each individual word into its constituent phonemes. The exemplary embodiments, instead, combine phrases and concatenate each phrase's sequential strings of phonemes.

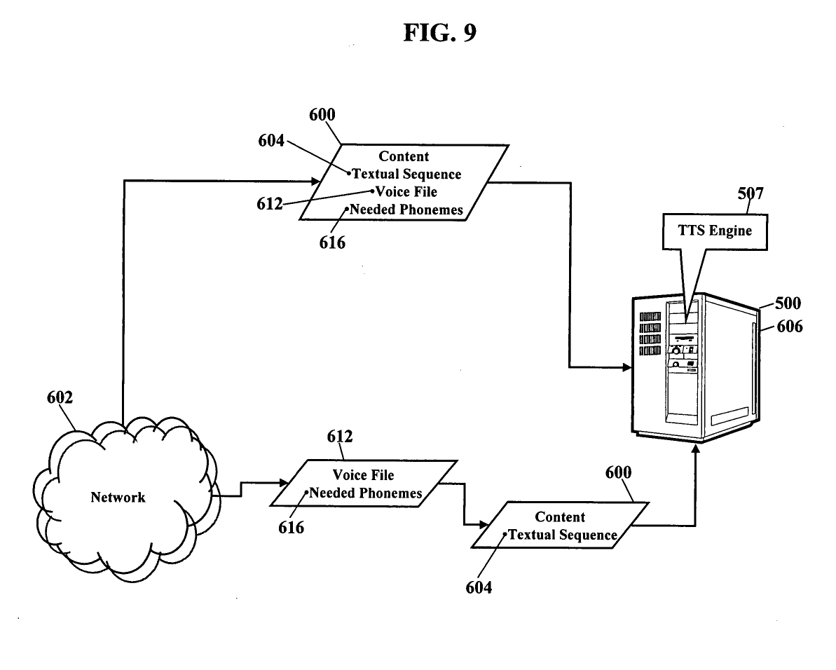

FIG. 9 is a schematic further illustrating the voice file 612, according to more exemplary embodiments. When the TTS engine 507 receives the content 600, the voice file 612 accompanies the content 600. The voice file 612 may be packetized with the content 600, or the voice file may be an attachment to the content 600. Here, however, the voice file 612 only comprises those phonemes 616 needed to translate the content 600 to speech. That is, the accompanying voice file 612 does not contain a full library of phrases, pairings, syllables, and other phoneme sequences. The voice file 612, instead, only contains the phonemes necessary to translate the textual sequences present in the content 600. The voice file 612, then, may be much smaller in size than a full matrix. If a message only contains a short “want to go to lunch,” it's inefficient to send an entire matrix of phonemes. Because the voice file 612 may only contain limited phonemes, this smaller voice file 612 is particularly suited to instant messages and mail messages. The voice file 612, however, could accompany any content. FIG. 9 illustrates that the voice file 612 may be sent with the content 600, or the voice file 612 may be sent as a separate communication.

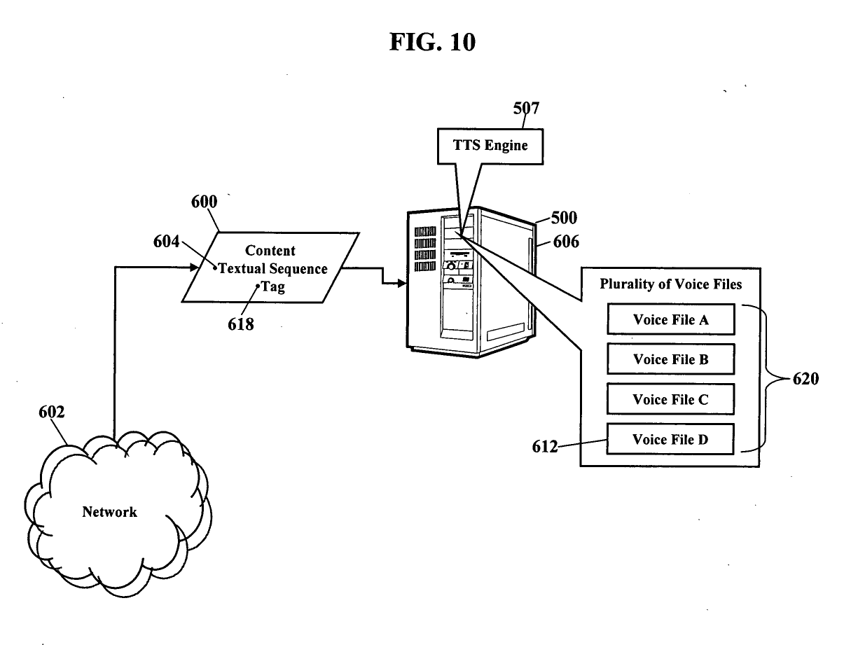

FIG. 10 is a schematic illustrating a tag 618, according to more exemplary embodiments. Here, when the TTS engine 507 receives the content 600 from the network 602, that content 600 is accompanied by a tag 618. The tag 618 uniquely identifies which voice file is to be used when translating text to speech. As the paragraphs above explained, there may be a plurality 620 of voice files, with each voice file 612 having the characteristics of a known speaker. Each speaker's voice file contains that speaker's distinct sounds, auditory representations, and identifiers. Each speaker's voice file uniquely characterizes that speaker's speech speed, emphasis, rhythm, pitch, and pausing. One voice file, for example, could contain the speech characteristics of Humphrey Bogart, another voice file could contain John Wayne's speech characteristics, and still another voice file could contain Darth Vader's speech characteristics (DARTH VADER® is a registered trademark of Lucasfilm, Ltd., www.lucasfilm.com). Any speaker, in fact, may record their own voice file, as previously explained. Voice files may be created by splicing existing recordings (such as for deceased actors, politicians, and any other person). Because there can be many voice files, the tag 618 uniquely identifies which voice file is to be used when translating text to speech. The tag 618, then, determines in whose voice the textual sequence is translated to speech.

The content 600, then, is translated using the desired speaker's speech. Suppose, for example, the tag 618 accompanies an electronic message (again, perhaps a mail message, an instant message, or any textual content). When the TTS engine 507 receives the electronic message, the TTS engine 507 identifies the textual sequence 604 and correlates the textual sequence 604 to the one or more phrases 608. The TTS engine 507 interprets the tag 618 and accesses the voice file 612 identified by the tag 618. The identified phrases are then mapped to their corresponding sequential strings of phonemes. When those sequential strings of phonemes are processed, the resultant speech has the characteristics of the speaker's tagged voice file. The electronic message, then, is translated to speech in the speaker's voice.

The tag 618 may be ignored. Although the tag 618 uniquely identifies which voice file is used when translating text to speech, a user of the translation device 500 may not like the tagged voice file. Suppose an electronic mail message is received, and that message is tagged to Darth Vader's voice file. That is, perhaps a sender has tagged the mail message so that it is translated using Darth Vader's speech characteristics. The voice of DARTH VADER®, however, may not be desirable, or perhaps even offensive, to the recipient. The TTS engine 507, then, may be configured to permit overriding the tag 618. The TTS engine 507 may permit a user to individually override each tag. The TTS engine 507 may additionally or alternatively permit a global configuration that specifies types of content and their associated voice files. The TTS engine 507 thus allows the user to further customize how content is translated into speech.

Exemplary embodiments may also have device-level overrides. The TTS engine 507 may recognize configurations based on the receiving device. Suppose a sender sends a message, and the subject line of the message is tagged to “Darth Vader's” voice file. When the TTS engine 507 receives the message, the sender intends that the TTS engine will translate the subject line to speech using Darth Vader's voice. That audio translation, however, might not be appropriate in certain situations. The recipient of the message, for example, may not want Darth Vader's voice in a work environment. The TTS engine 507, then, may sense on what device the message is being received, and the TTS engine applies that device's configuration parameters to the message. The TTS engine 507, then, will override the sender's desired personalization settings and, instead, apply the recipient's translation settings. The recipient-user may specify rules that substitute another voice file (e.g., a generic, less objectionable voice) or even a default setting (e.g., no speech translation on the work device). The TTS engine 507 could base these rules on the recipient's communications address, on a unique processor or other hardware identification number, or on software authentication numbers.

The TTS engine 507 may permit global or theme configurations. The TTS engine 507 may have settings and/or rules that permit the user to select how certain types of content are translated into speech. Perhaps the user desires that all textual attachments (such as MICROSOFT® WORD® files) are translated into speech using a soothing voice. The TTS engine 507, then, would have a configuration setting that specifies what voice file is used when translating textual attachments. Perhaps the user desires that all electronic messages are translated using a spouse's voice, so a configuration setting would permit selecting the spouse's voice file for received messages. Whatever the content, the user could associate a voice file to types of content. The TTS engine could even translate system messages into speech using the user's desired voice file. Perhaps Humphrey Bogart's voice says “Windows is processing your request, please wait” or “Internet Explorer is downloading a webpage” (WORD®, WINDOWS®, and INTERNET EXPLORER® are registered trademarks of Microsoft Corporation, One Microsoft Way, Redmond Wash. 98052-6399, 425.882.8080, www.Microsoft.com).

The user may also associate addresses to voice files. The TTS engine 507 may be configured such that senders of messages are associated with voice files. Suppose, again, a spouse sends a mail message. When the TTS engine 507 translates the spouse's message to speech, a configuration setting would associate the spouse's communications address to the spouse's voice file. Friends, coworkers, and family could all have their respective messages translated using their respective voice files. Because the TTS engine 507 translates any content, the TTS engine could be configured to associate email addresses, website domains, IP addresses, and even telephone numbers to voice files. Whatever the communications address, the communications address may have its associated voice file.

The user may even associate phrases to voice files. The user may have a preferred speaker for certain phrases. Whenever “here's looking at you, kid” appears in textual content, the user may want that phrase translated using Humphrey Bogart's voice. The TTS engine 507, then, may allow the user to associate individual phrases to voice files. The TTS engine 507 maintains a matrix of phrases and voice files. The user associates each phrase to their desired voice file. When that phrase is encountered, the TTS engine 507 maps that phrase to the sequential string of phonemes from the desired voice file. That sequential string of phonemes is then processed so that the phrase is translated in the voice of the desired speaker.

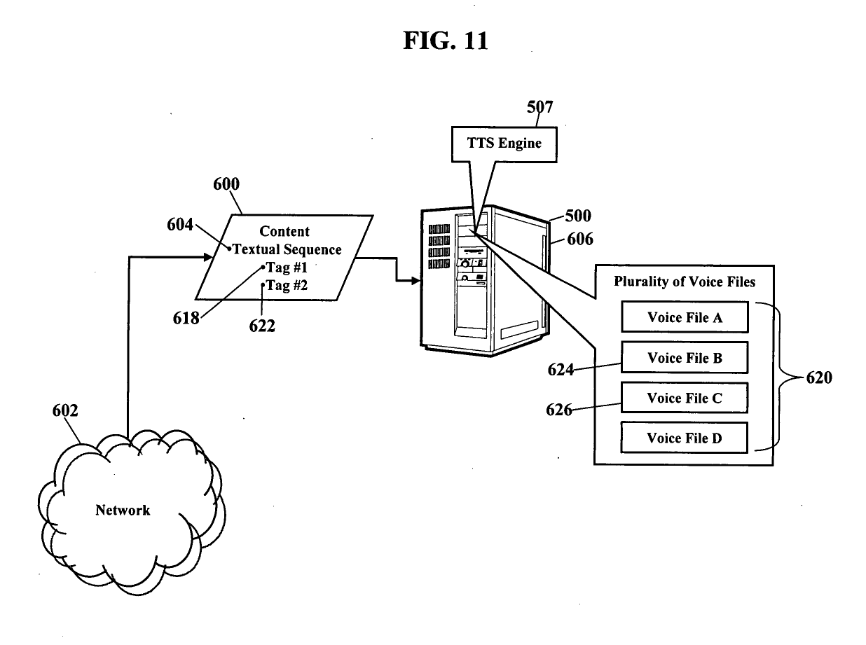

FIG. 11 is a schematic illustrating “morphing” of voice files, according to still more exemplary embodiments. Here the TTS engine 507 combines the speech characteristics of at least two speakers to the same translated phrase. That is, the TTS engine 507 maps the same phrase in different matrixes of different voice files. The TTS engine 507 then retrieves and simultaneously processes each corresponding sequential string of phonemes. Because these sequential strings of phonemes map to the same phrase, the phrase is translated into speech having attributes of each speaker's voice.

As FIG. 11 illustrates, the TTS engine 507 receives the content 600 from the network 602. The content 600 may be accompanied by at least two tags 618 and 622, with each tag uniquely identifying the respective voice file to be used when translating text to speech. Alternatively, the user may configure the TTS engine 507 to access two or more voice files as part of a global or theme preference for particular types of content (as discussed above). Regardless, the TTS engine 507 accesses at least two voice files 624 and 626. The identified phrase is then mapped to the corresponding sequential strings of phonemes in each voice file 624 and 626. When those sequential strings of phonemes are simultaneously processed, the resultant speech has the characteristics of the speaker's voice file. Suppose, again, the user wants all electronic messages translated to speech in the combined voices of the user's children. Any textual sequences in an electronic message are translated using the voice files of the children. When the electronic message is translated to speech, the resultant speech is morphed to have the characteristics of each child's voice.

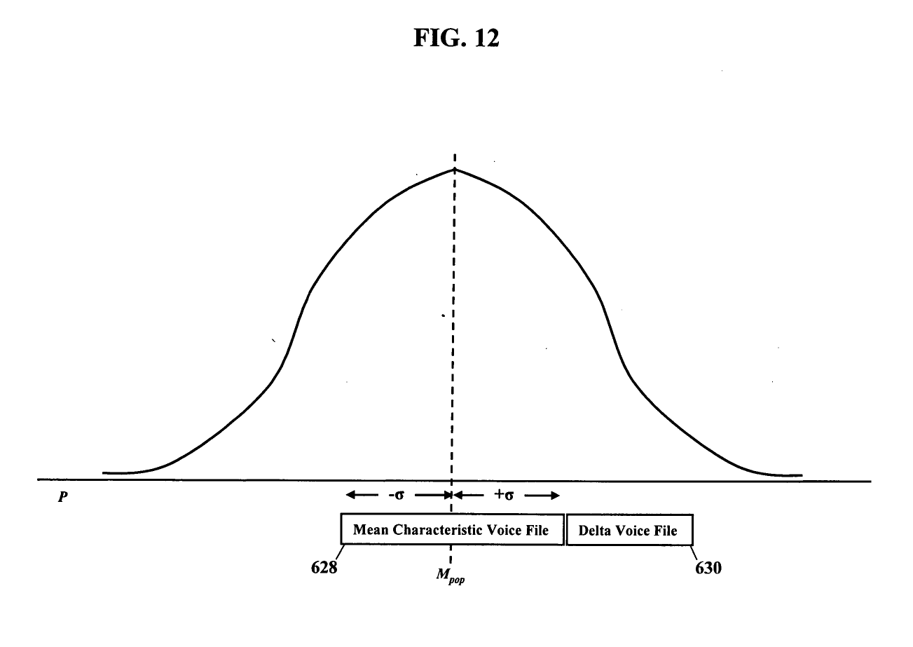

FIG. 12 is a schematic illustrating delta voice files, according to yet more exemplary embodiments. The previous paragraphs mentioned how a plurality of voice files may be stored or accessed, with each voice file containing the speech characteristics of a speaker's voice. Each voice file could be large in bytes, especially if the voice files contain many phrases and/or phonemes. As the number of voice files grows, storage space may become limited. Yet, despite each speaker seemingly having a unique voice, there is generally some consistency and/or similarities in some or all voices. Some or all female voices, for example, may contain similar speech characteristics. Males, likewise, may contain similar speech characteristics. There may be similarities due to geographic location, dialects, and/or ethnicity. The exemplary embodiments, then, may then store or pre-distribute these common characteristics. An individual speaker's delta characteristics could be separately received and stored. These “delta” characteristics represent the speaker's differences from the common characteristics. The exemplary embodiments thus utilize a base dictionary with a set of “delta” parameters for each specific individual speaker, as opposed to having a custom dictionary for each individual voice.

FIG. 12 graphically illustrates a Gaussian distribution of a population P of speakers. The mean Mₚₒₚ describes the mean value of a characteristic of the population. The Gaussian distribution describes the probability that an individual speaker will have that characteristic. Because a Gaussian distribution is well known to those of ordinary skill in the art, this patent will not provide a further explanation.

FIG. 12 also illustrates a mean characteristic voice file 628 and a speaker's delta voice file 630. The mean characteristic voice file 628 contains one or more of the voice characteristics that are common to the population P of speakers. The larger the mean characteristic voice file 628, the larger the common characteristics. The speaker's delta voice file 630, on the other hand, contains unique voice characteristics that are unique to an individual speaker. So, the larger the mean characteristic voice file 628, the more the voice file contains characteristics that are common to the population. The mean characteristic voice file 628, for example, may contain one, two, or three standard deviations (e.g., ±σ, ±2σ, or ±3σ). If the mean characteristic voice file 628 is large (e.g., contains ±3σ standard deviations), then the speaker's delta voice file 630 can be small in size. If, however, the mean characteristic voice file 628 is too large, then bandwidth transmission or storage space may be limited. So the mean characteristic voice file 628 and the speaker's delta voice file 630 may be dynamically sized to suit network capabilities, processor performance, and other software and hardware configurations.

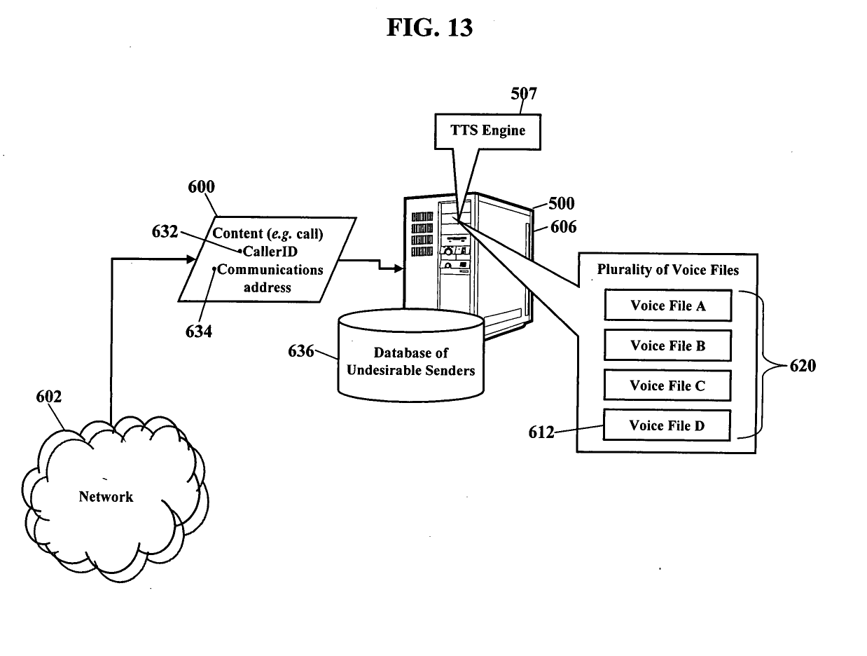

FIG. 13 is a schematic illustrating authentication of translated speech, according to exemplary embodiments. Here the exemplary embodiments are used to authenticate the sender of the content. This authentication, however, is based on the sender's voice. Currently authentication is usually based on an address (such as a verified email address or a known telephone number). The exemplary embodiments, however, compare a known speaker's unique voice file to actual speech. If the actual speech matches the speaker's stored voice characteristics in the voice file, then the content is accepted. If, however, the speech is unlike the speaker's unique voice characteristics, then exemplary embodiments delete or otherwise filter that content.

The exemplary embodiments authenticate a sender. The TTS engine 507 receives the content 600 from the network 602. Suppose the content 600 is a POTS telephone call or a VoIP call (the content 600, however, could be any electronic message comprising audible content). As a caller speaks, the TTS engine 507 compares that caller's voice characteristics to those stored in the speaker's voice file 612. The TTS engine 507 may use spectral analysis or any voice recognition technique that can uniquely discern a person's individual speech characteristics. If the characteristics match to within some threshold, then the identity of the caller is authenticated. If the caller's speech characteristics lie outside the threshold, then the identity of the caller cannot be verified. When authentication fails, the TTS engine 507 may be configured to handle the call (such as denying the call, playing a stored rejection message, or storing the call in memory).

The exemplary embodiments may authenticate using the sender's communications address. Suppose, again, the content 600 is a POTS telephone call or a VoIP call. The call is accompanied by CallerID signaling 632. The TTS engine 507 uses the CallerID signaling 632 to select the voice file. The TTS engine 507 maintains a database (not shown) that associates voice files to CallerID numbers. When a call is received from the spouse's mobile phone, the TTS engine 507 uses CallerID to select the spouse's corresponding voice file. As a caller speaks, the TTS engine 507 compares that caller's voice characteristics to those stored in the spouse's voice file 612. If the characteristics match, then the identity of the spouse is authenticated. If the caller's speech characteristics lie outside the threshold, then the identity of the caller cannot be verified. The TTS engine 507 may alternatively or additionally use nay communications address 634, such as an email address, IP address, domain name, or any other communications address when selecting the voice file.

The exemplary embodiments may control or reduce “spam” communications. Even if a communications address 634 is unknown, the exemplary embodiments could still filter based on speech characteristics. The exemplary embodiments maintain a database 636 of undesirable senders of communications. This database 636 contains voice characteristics for each undesirable sender. Even if a sender uses an unknown communications address, exemplary embodiments would still compare the sender's actual speech to the database 636 of undesirable senders of communications. If a match is again found (perhaps to within a configurable threshold), then the identity of the sender is discovered. Exemplary embodiments, then, “catch” undesirable senders/callers, even if they use new or unknown addresses/numbers.

Exemplary embodiments also store speech characteristics. Suppose a caller's speech patterns are unknown—that is, no voice file exists that describes the caller's speech characteristics. The TTS engine 507, then, cannot authenticate the caller. The TTS engine 507 may be configured to record, save, or analyze the caller's speech characteristics. The user could then label those characteristics as “acceptable” or “undesirable” (or any other similar designation). If the caller is a friend or family member, then the user labels the caller's speech characteristics as “acceptable.” If, however, the caller is a telemarketer or other undesirable person, then the user labels the caller's speech characteristics as “undesirable.” The TTS engine 507 then adds those undesirable speech characteristics to the database 636 of undesirable senders. Future calls from that undesirable caller are then filtered based on speech characteristics. Exemplary embodiments, of course, are applicable to an “undesirable” sender of any communication, not just telemarketing calls.

Exemplary embodiments, then, are immune to changes in communications addresses. Because the exemplary embodiments verify using speech, exemplary embodiments are unaffected by changes in telephone numbers, email addresses, and other communications addresses. Telemarketers, for example, often change their calling telephone numbers to thwart privacy systems. Email spammers often change or hide their mail addresses. The exemplary embodiments, however, would not accept any communication that possesses “undesirable” speech characteristics.

Exemplary embodiments may analyze only small phrases. When the TTS engine 507 analyzes the sender's/caller's speech characteristics, the TTS engine 507 may analyze only a short “test phrase.” When the test phrase is spoken by the caller/sender, the TTS engine 507 quickly analyzes that test phrase to determine whether the speaker is “acceptable” or “undesirable.” The test phrase may be the same for all senders, or the test phrase may be associated to the communications address. That is, certain speakers may have different test phrases, based on their communications address. The test phrase may also be chosen such that differences in each speaker's speech characteristics are emphasized. Whatever the test phrase, the TTS engine 507 may quickly and efficiently authenticate the sender.

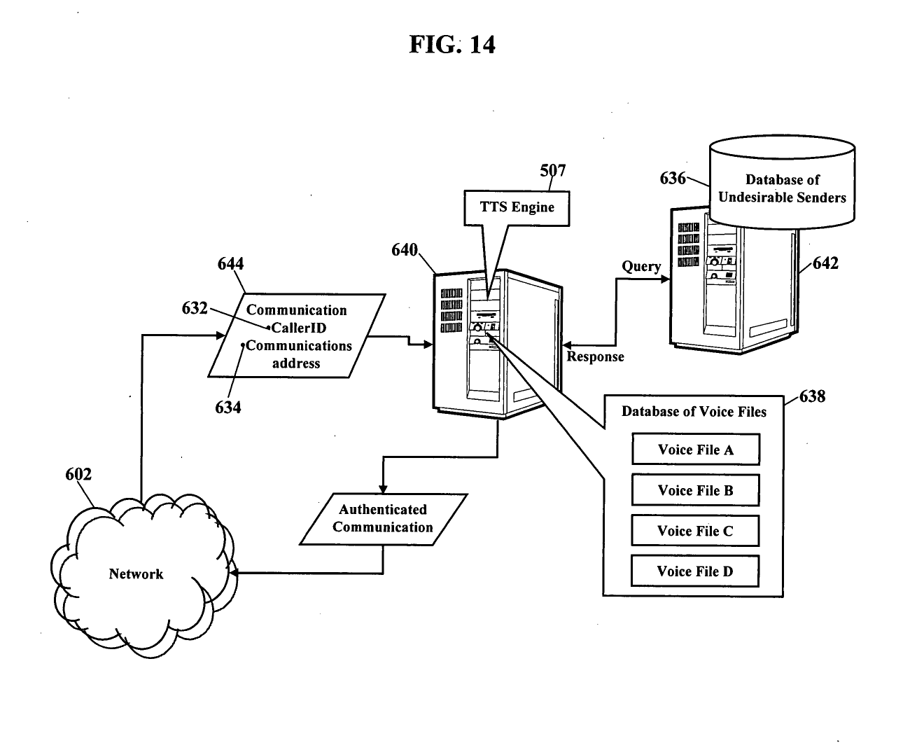

FIG. 14 is a schematic illustrating a network-centric authentication, according to exemplary embodiments. Here the exemplary embodiments are applied to service providers and/or network operators (hereinafter “operator”). The operator offers an authentication service employing the exemplary embodiments. The service provider and/or the network operator process communications based on speech characteristics of the sender. Customers could subscribe to this authentication service, and the service provider and/or a network operator authenticates communications on behalf of the subscriber. Individual speakers' voice files are maintained in a database 638 of voice files. The database 638 of voice files stores within a server 640 operating in the network 602. The database 636 of undesirable senders is stored within another server 642 operating in the network 602. These databases 636 and 638 are maintained on behalf of the subscriber. As the operator processes a communication 644, the operator analyzes the communication 644 and/or the sender's speech, as above explained. The operator could charge a fee for thus authentication service.

Exemplary embodiments may be applied to virtual business cards. Many electronic messages are accompanied by a sender's V-card. This V-card includes contact information for the sender, and may be automatically added to an address book. The sender's V-card, however, could also include the sender's distinct sounds, auditory representations, and identifiers (earlier described as the sender's “voice” font). Any electronic communications from that sender could be translated to speech using the sender's voice font. The sender could also be authenticated using the voice font, as earlier described. The V-card could even specify that the sender wishes all their electronic communications to be not only translated to speech, but also translated into a different language. A service provider or network operator may, as earlier mentioned, provide this service.

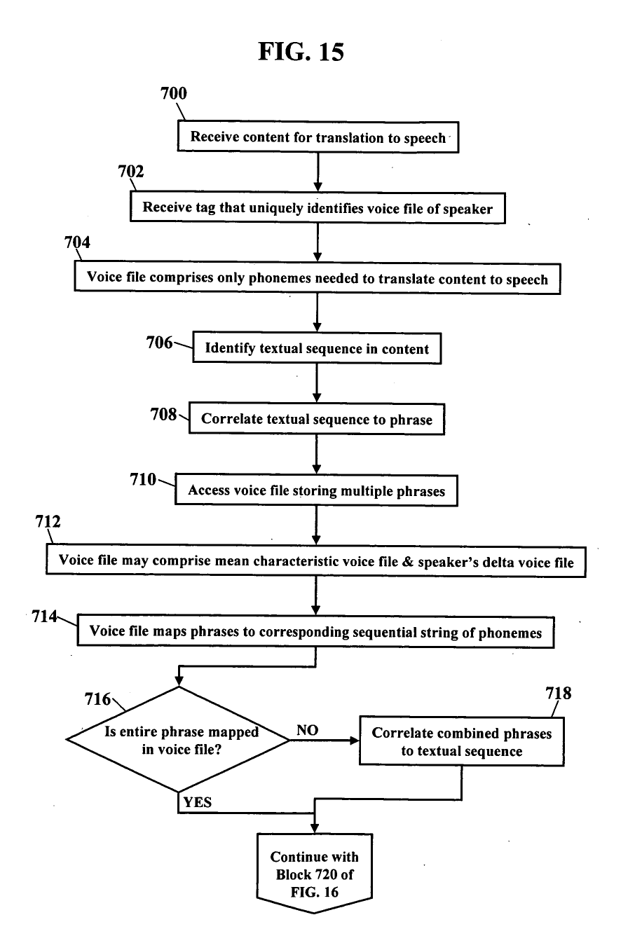

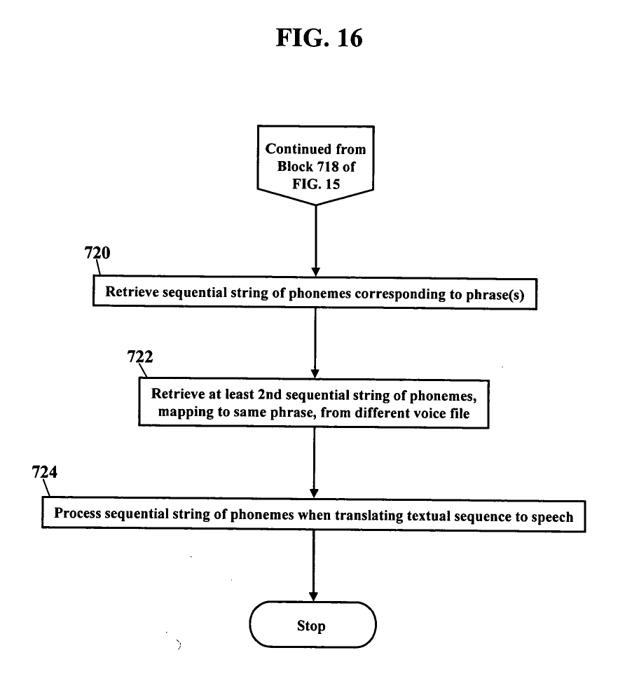

FIGS. 15 and 16 are flowcharts illustrating a method of translating text to speech, according to exemplary embodiments. Content is received for translation to speech (Block 700). A tag that uniquely identifies the voice file of a speaker may be received (Block 702). The voice file may accompany the content, such that the voice file comprises only those phonemes needed to translate the content to speech (Block 704). A textual sequence in the content is identified (Block 706). The textual sequence is correlated to a phrase (Block 708). A voice file storing multiple phrases is accessed (Block 710). The voice file may be a mean characteristic voice file and a speaker's delta voice file (Block 712). The mean characteristic voice file contains common voice characteristics that are common to a population of speakers, and the speaker's delta voice file contains unique voice characteristics that are unique to that speaker. The voice file maps phrases to a corresponding sequential string of phonemes stored in the voice file. (Block 714). If the entire phrase is not found in the matrix (Block 716), then combined phrases are correlated to the textual sequence (Block 718).

The flowchart continues with FIG. 16. A sequential string of phonemes, corresponding to the phrase(s), is retrieved (Block 720). At least a second sequential string of phonemes may be retrieved from a different voice file, with the at least two sequential strings of phonemes mapping to the same phrase (Block 722). The sequential string of phonemes is processed when translating the textual sequence to speech (Block 724).

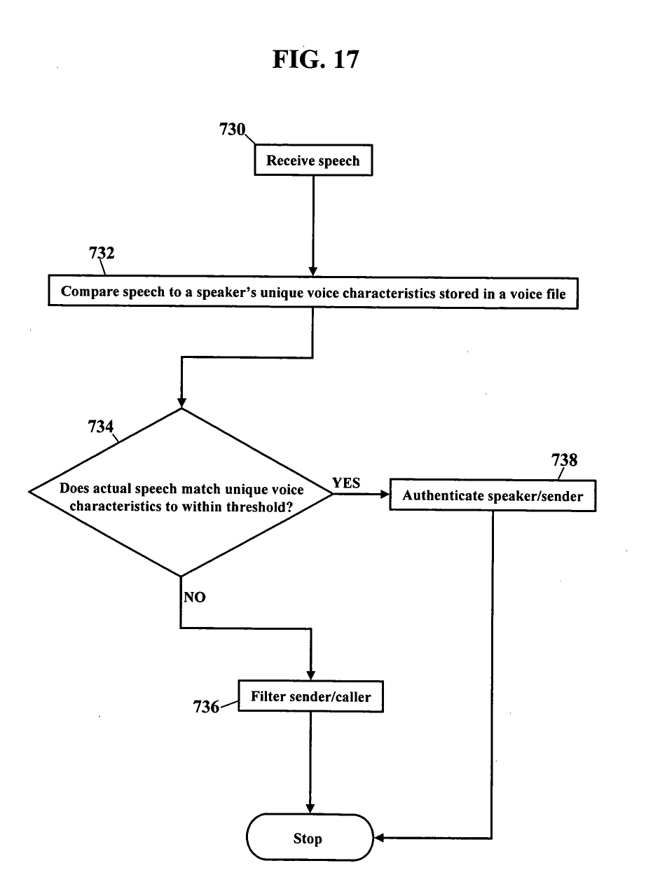

FIG. 17 is a flowchart illustrating a method of authenticating speech, according to more exemplary embodiments. Speech is received (Block 730). That speech is compared to a speaker's unique voice characteristics stored in a voice file to authenticate an identity of a sender of the content (Block 732). If the actual speech is unlike the unique voice characteristics stored in the voice file (Block 734), then the sender/caller is filtered (Block 736). If the speaker's unique voice characteristics match to within a threshold (Block 734), then the speaker is authenticated (Block 738).

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of translating text to speech, comprising:
receiving content for translation to speech;
identifying a textual sequence in the content;
correlating the textual sequence to a phrase;
accessing a voice file storing multiple phrases, the voice file mapping each phrase to a corresponding sequential string of phonemes stored in the voice file;
retrieving the sequential string of phonemes corresponding to the phrase; and
processing the sequential string of phonemes when translating the textual sequence to speech.

2. A method according to claim 1, further comprising receiving a tag that uniquely identifies the voice file of a speaker, such that the textual sequence is translated to speech using the speaker's voice.

3. A method according to claim 1, further comprising correlating combined phrases to the textual sequence, such that at least two sequential strings of phonemes are combined and processed when translating the textual sequence to speech.

4. A method according to claim 1, further comprising combining at least two sequential strings of phonemes from different voice files of different speakers, with the at least two sequential strings of phonemes mapping to the same phrase, such that the textual sequence is translated into speech having attributes of each speaker's voice.

5. A method according to claim 1, wherein the step of accessing the voice file comprises accessing a mean characteristic voice file and accessing a speaker's delta voice file, the mean characteristic voice file containing common voice characteristics that are common to a population of speakers, and the speaker's delta voice file containing unique voice characteristics that are unique to that speaker.

6. A method according to claim 1, further comprising:
comparing a speaker's unique voice characteristics stored in the voice file to actual speech to authenticate an identity of a sender of the content; and
if the actual speech is unlike the unique voice characteristics stored in the voice file, then filtering the content.

7. A method according to claim 1, wherein the step of receiving the content comprises receiving the voice file that accompanies the content, the voice file comprising only those phonemes needed to translate the content to speech.

8. A system, comprising:
a text-to-speech translation engine stored in storage; and
a processor communicating with the storage, the text-to-speech translation application receiving content for translation to speech, identifying a textual sequence in the content, and correlating the textual sequence to a phrase;
the text-to-speech translation application accessing a voice file storing multiple phrases, the voice file mapping each phrase to a corresponding sequential string of phonemes stored in the voice file;
the text-to-speech translation application retrieving the sequential string of phonemes corresponding to the phrase and processing the sequential string of phonemes when translating the textual sequence to speech.

9. A system according to claim 8, the text-to-speech translation application further receiving a tag that uniquely identifies the voice file of a speaker, such that the textual sequence is translated to speech using the speaker's voice.

10. A system according to claim 8, the text-to-speech translation application further correlating combined phrases to the textual sequence, such that at least two sequential strings of phonemes are combined and processed when translating the textual sequence to speech.

11. A system according to claim 8, the text-to-speech translation application further combining at least two sequential strings of phonemes from different voice files of different speakers, with the at least two sequential strings of phonemes mapping to the same phrase, such that the textual sequence is translated into speech having attributes of each speaker's voice.

12. A system according to claim 8, wherein when the text-to-speech translation application accesses the voice file, the text-to-speech translation application accesses a mean characteristic voice file and accesses a speaker's delta voice file, the mean characteristic voice file containing common voice characteristics that are common to a population of speakers, and the speaker's delta voice file containing unique voice characteristics that are unique to that speaker.

13. A system according to claim 8, the text-to-speech translation application i) comparing a speaker's unique voice characteristics stored in the voice file to actual speech to authenticate an identity of a sender of the content, and ii) if the actual speech is unlike the unique voice characteristics stored in the voice file, then filtering the content.

14. A system according to claim 8, wherein when the text-to-speech translation application receives the content, the voice file accompanies the content, the voice file comprising only those phonemes needed to translate the content to speech.

15. A computer program product comprising computer-readable instructions for performing the steps:
receiving content for translation to speech;
identifying a textual sequence in the content;
correlating the textual sequence to a phrase;
accessing a voice file storing multiple phrases, the voice file mapping each phrase to a corresponding sequential string of phonemes stored in the voice file;
retrieving the sequential string of phonemes corresponding to the phrase; and
processing the sequential string of phonemes when translating the textual sequence to speech.

16. A computer program product according to claim 15, further comprising instructions for receiving a tag that uniquely identifies the voice file of a speaker, such that the textual sequence is translated to speech using the speaker's voice.

17. A computer program product according to claim 15, further comprising instructions for correlating combined phrases to the textual sequence, such that at least two sequential strings of phonemes are combined and processed when translating the textual sequence to speech.

18. A computer program product according to claim 15, further comprising instructions for combining at least two sequential strings of phonemes from different voice files of different speakers, with the at least two sequential strings of phonemes mapping to the same phrase, such that the textual sequence is translated into speech having attributes of each speaker's voice.

19. A computer program product according to claim 15, further comprising instructions for:
accessing a mean characteristic voice file and accessing a speaker's delta voice file, the mean characteristic voice file containing common voice characteristics that are common to a population of speakers, and the speaker's delta voice file containing unique voice characteristics that are unique to that speaker;
comparing the unique voice characteristics stored in the speaker's delta voice file to actual speech to authenticate an identity of a sender of the content; and
if the actual speech is unlike the unique voice characteristics stored in the speaker's delta voice file, then filtering the content.

20. A computer program product according to claim 15, wherein the instructions for receiving the content comprise instructions receiving the voice file that accompanies the content, the voice file comprising only those phonemes needed to translate the content to speech.
